(19) United States
(12) Patent Application Publication
(10) Pub. No.: US 2005/0237004 A1
(43) Pub. Date: Oct. 27, 2005

(54) Method for operating a high-pressure discharge lamp

(75) Inventor: Michael Bonigk, Berlin (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, Munchen (DE)

(21) Appl. No.: 11/105,446

(22) Filed: Apr. 14, 2005

(30) Foreign Application Priority Data
Apr. 23, 2004 (DE) 102004020397.0

(51) Int. Cl. H05B 37/02

(52) U.S. Cl. 315/224; 315/291

(57) ABSTRACT

The invention relates to a method for operating a high-pressure discharge lamp using a bipolar supply current, which has a temporally cyclic waveform, and a predetermined electrical power, the high-pressure discharge lamp being supplied with an additional electrical power at cyclically repeating time intervals directly following the zero crossing of the supply current in order to stabilize the lamp operation, and the total power, averaged over time, corresponding to the predetermined electrical power.

### I. TECHNICAL FIELD

The invention relates to a method for operating a high-pressure discharge lamp using a bipolar supply current, which has a temporally cyclic waveform, and a predetermined electrical power.

### II. BACKGROUND ART

A method for operating a high-pressure discharge lamp by means of a bipolar supply current is described, for example, on pages 217 and 218 in the book “Betriebsgeräte und Schaltungen für elektrische Lampen” [Operating devices and circuits for electric lamps] by C. H. Sturm and E. Klein, Siemens AG, 6^{th} revised edition, 1992. This reference discloses the operation of a high-pressure discharge lamp using a bipolar supply current which has an essentially square-wave waveform.

High-pressure discharge lamps require a defined energetic budget for ordinary operation. If its energy budget is disturbed, changes in the operating behavior of the high-pressure discharge lamp result, for example a shortening of the lamp life owing to electrode erosion or flickering caused by an undefined discharge arc formation. When operating the high-pressure discharge lamp using a bipolar supply current, the zero crossing of the supply current at its polarity reversal represents a critical operating phase of the lamp. In particular in the case of high-pressure discharge lamps having relatively thick electrodes, which have high heat conductance, such as in the case of mercury-free halogen metal-vapor high-pressure discharge lamps, the increased transfer of heat during the zero crossing of the supply current brings about correspondingly greater cooling of the lamp electrodes.

In this case, the power supplied to the high-pressure discharge lamp may lead to insufficient heating of the lamp electrodes prior to the polarity reversal of the supply current. Correspondingly, the lamp electrodes have a reduced emission capability, and the voltage, which is available following the polarity reversal, over the entire system, i.e. over the discharge arc and the electrodes, is insufficient for maintaining the corresponding current flow or for providing it as quickly as possible. Flickering of the discharge arc may therefore be observed in the high-pressure discharge lamp. This is particularly the case for severely aged lamps.

### III. DISCLOSURE OF THE INVENTION

It is the object of the invention to prevent the above described problem during operation of the high-pressure discharge lamps using a bipolar, temporally cyclic supply current. In particular, it is also intended to provide a reliable operating method for mercury-free halogen metal-vapor high-pressure discharge lamps.

This object is achieved according to the invention by a method for operating a high-pressure discharge lamp using a bipolar supply current, which has a temporally cyclic waveform, and a predetermined electrical power,
wherein the high-pressure discharge lamp is supplied with an additional electrical power at cyclically repeating time intervals directly following the zero crossing of the supply current, and the total power, averaged over time, corresponding to the predetermined electrical power. Particularly advantageous embodiments of the invention are described in the dependent patent claims:

It has surprisingly been found that it is not the preheating of the electrodes prior to commutation, i.e. the polarity reversal of the supply or lamp current, which is of critical importance, but it is the provision or supply of an overload directly following commutation. Supplying an additional power directly following commutation ensures, in particular owing to the use of the voltage increase caused by the electrode (so-called electrode fall voltage), which results in a higher power input to the electrode and thus in more rapid heating or in a more rapid transition to a stable state, flicker-free operation of the high-pressure discharge lamp. If this electrode fall voltage cannot be completely used, the heating lasts for a very long period of time and the electrode remains in a mode having a low current flow with more or less undefined arc spotting, corresponding discharge arc movement and increased electrode erosion over this period of time.

The method according to the invention for operating a high-pressure discharge lamp using a bipolar supply current, which has a temporally cyclic waveform, and a predetermined electrical power is characterized in that the high-pressure discharge lamp is supplied with an additional electrical power at cyclically repeating time intervals directly following the zero crossing of the supply current, the total power, averaged over time, corresponding to the predetermined electrical power. The cyclically repeating time intervals during which the additional electrical power is provided for the high-pressure discharge lamp are arranged such that they are near in time to the polarity reversal of the supply current of the high-pressure discharge lamp. These time intervals are advantageously arranged not only directly following the polarity reversal but in addition also directly prior to the polarity reversal or the zero crossing of the supply current. The additional power supply prior to the polarity reversal of the supply current allows for correspondingly more severe system heating in order to take into account the cooling of the lamp electrodes during the zero crossing of the supply current and to counteract the abovementioned disadvantages resulting therefrom. The critical additional power supply following the polarity reversal of the supply current serves the purpose of heating the cooled lamp electrodes as quickly as possible by using the so-called electrode fall voltage and a higher power consumption associated therewith.

The durations of the cyclically repeating time intervals for the additional power supply are preferably in each case 1 percent to 40 percent of the duration of one half-cycle of the supply current. The instantaneous value of the additional electrical power, which is impressed during the cyclically repeating time intervals of the high-pressure discharge lamp, is preferably in the range from 1 percent to 300 percent of the value of the predetermined electrical power.

The operating method according to the invention also makes it possible to dim, i.e. to regulate the brightness of, the high-pressure discharge lamp. For the dimming operation, it is thus possible for the total power, averaged over time, of the high-pressure discharge lamp to be adjusted to a value which is lower than the rated power for the high-pressure discharge lamp.

### IV. BRIEF DESCRIPTION OF THE DRAWINGS

The invention will be explained in more detail below with reference to a preferred exemplary embodiment. In the drawing:

FIG. 1 shows the waveform of the current, the voltage and the electrical power of a mercury-free halogen metal-vapor high-pressure discharge lamp during operation at its rated power, and

FIG. 2 shows the waveform of the current, the voltage and the electrical power of the mercury-free halogen metal-vapor high-pressure discharge lamp during operation at a lower power than its rated power.

### V. BEST MODE FOR CARRYING OUT THE INVENTION

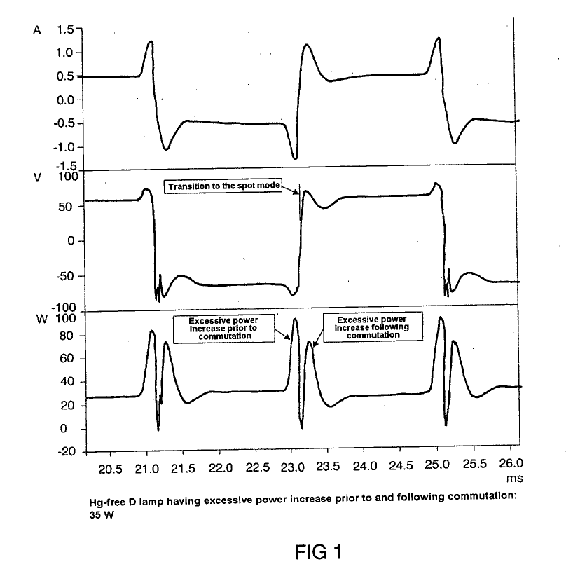

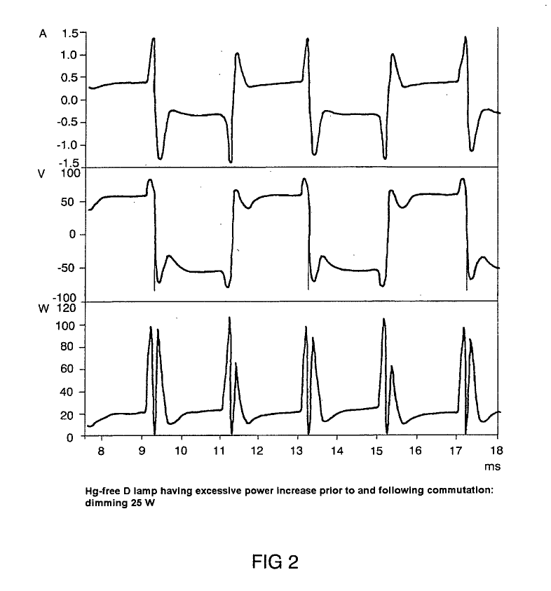

Using FIGS. 1 and 2, the operating method according to the invention is described with reference to a severely aged mercury-free halogen metal-vapor high-pressure discharge lamp, which is envisaged for use in the headlamp of a motor vehicle and has a rated power of 35 watts. This lamp has a discharge vessel made of quartz glass having an ionizable filling enclosed therein and electrodes arranged therein for producing a light-emitting gas discharge. The ionizable filling contains xenon and halogen compounds of the metals sodium, scandium, zinc and indium.

This mercury-free halogen metal-vapor high-pressure discharge lamp is supplied with a bipolar supply current, which has an essentially square-wave waveform, by means of an operating device, whose basic circuit arrangement is described on the pages of the above-cited book.

The frequency of this square-wave, bipolar supply current of the lamp and its square-wave, bipolar supply voltage which is in phase with said supply current is approximately 250 hertz. In the drawings, FIG. 1 illustrates the waveform of the supply current and of the supply voltage and the instantaneous electrical power of the lamp in their conventional units, amperes, volts and watts. The time axis is scaled in units of milliseconds. The duration of one half-cycle of the supply current and of the supply voltage is in each case 2 milliseconds. The supply current is approximately 0.5 amperes or −0.5 amperes during the majority of a positive or negative half-cycle. In analogy thereto, the supply voltage is approximately 50 volts or −50 volts during the majority of a positive or negative half-cycle. Only directly prior to and following the polarity reversal of the supply current and of the supply voltage do the abovementioned variables assume considerably higher values, with the result that at this time there is an increased power input to the lamp. The time duration of the increased power input is in each case 11 percent of one half-cycle of the supply current, i.e. approximately 0.22 milliseconds, prior to and following the polarity reversal of the supply current. The instantaneous electrical power consumption of the lamp has a virtually constant value of approximately 30 watts during the majority of the positive and negative half-cycles of the supply current. Directly prior to each polarity reversal of the supply current, an electrical power of approximately 95 watts is impressed on the lamp during a time interval of in each case 0.22 milliseconds, and directly following each polarity reversal of the supply current, an electrical power of approximately 80 watts is impressed on the lamp during a time interval of likewise in each case 0.22 milliseconds. The power consumption, which has been averaged over the entire period or over one cycle of the supply current, of the lamp is approximately 35 watts.

In the figures, FIG. 2 illustrates the waveform of the supply current, the supply voltage and the instantaneous electrical power for the same mercury-free halogen metal-vapor high-pressure discharge lamp for the case in which this lamp is operated in the dimmed state, i.e. at an average power consumption of only 25 watts in place of its rated power of 35 watts. The instantaneous electrical power consumption of the lamp has a virtually constant value of approximately 20 watts during the majority of the positive and negative half-cycles of the supply current. Directly prior to and following each polarity reversal of the supply current, an electrical power of up to 100 watts is impressed on the lamp during a time interval of in each case 0.22 milliseconds. The power consumption, averaged over the entire period, of the lamp is approximately 25 watts.

Dimming of this lamp during standard operation or else merely a power increase directly prior to the zero crossing of its supply current would result in the lamp being extinguished.

1. A method for operating a high-pressure discharge lamp using a bipolar supply current, which has a temporally cyclic waveform, and a predetermined electrical power,
wherein the high-pressure discharge lamp is supplied with an additional electrical power at cyclically repeating time intervals directly following the zero crossing of the supply current, the total power, averaged over time, corresponding to the predetermined electrical power.

2. The method as claimed in claim 1, wherein the cyclically repeating time intervals are in addition also arranged directly prior to the zero crossing of the supply current.

3. The method as claimed in claim 1, wherein the durations of the cyclically repeating time intervals are in each case 1 percent to 40 percent of the total duration of one half-cycle of the supply current.

4. The method as claimed in claim 1, wherein the instantaneous value of the additional electrical power is in the range from 1 percent to 300 percent of the value of the predetermined electrical power.

5. The method as claimed in claim 1, wherein, for the purpose of dimming the high-pressure discharge lamp, the total power, averaged over time, is adjusted to a value which is lower than the predetermined electrical power.

6. The method as claimed in claim 2, wherein the durations of the cyclically repeating time intervals are in each case 1 percent to 40 percent of the total duration of one half-cycle of the supply current.

7. The method as claimed in claim 2, wherein the instantaneous value of the additional electrical power is in the range from 1 percent to 300 percent of the value of the predetermined electrical power.
